(19) United States
(12) Patent Application Publication
(10) Pub. No.: US 2004/0157149 A1
(43) Pub. Date: Aug. 12, 2004

(54) Object comprising an uncharged, functionalized hydrogel surface

(76) Inventor: Andreas Hofmann, Wallenfels (DE)

Correspondence Address: Striker Striker & Stenby, 103 East Neck Road, Huntington, NY, 11743, US

(21) Appl. No.: 10/477,095

(22) PCT Filed: May 9, 2001
(86) PCT No.: PCT/EP01/05288

(51) Int. Cl. G03C 5/18

(52) U.S. Cl. 430/141

(57) ABSTRACT

The invention relates to an object, such as a sensor or a microcavity with an uncharged, functionalized hydrogel surface, comprising a hydrogel, which has hydroxy groups to which organic molecules are bound. The molecules used have one or more radicals Λ and one or more radicals B. Radical Λ reacts with the hydroxy groups of the hydrogel when binding the organic molecule. Radical B is selected such that, after the organic molecule binds to the hydrogel, it reacts with a biomolecule having amino groups or thio groups without the use of one or more activation reagents. The invention also relates to a method for producing the inventive object and to novel organic molecules for binding biomolecules to a hydrogel.

The present invention relates to an article having an uncharged surface which comprises a hydrogel which is functionalized with radicals which make it possible to directly bind biomolecules possessing amino or thio groups, without any additional activating reagents, and to a process for producing it. The invention further-more relates to novel organic molecules for binding biomolecules to a hydrogel.

Surfaces for biotechnological applications can be functionalized with short linker molecules which, on account of their chemical reactivity, enable bio-molecules to be bound without any additional activating reagents being required (Pierce catalog, Coated Micro-well Plates, 1998). However, these surfaces are prone to nonspecific adsorptions which lead to the measured signal being falsified. In measurement methods which are based on affinity interaction, for example when using surface plasmon resonance (SPR) for analyzing biochemical interactions, this then falsely suggests that the concentration of biomolecules present in the solution is higher than it actually is.

It is furthermore known to provide surfaces with hydrogel layers in order to suppress nonspecific adsorption phenomena, with the hydrogel exhibiting additional functional radicals which enable biomolecules to be bound on. According to the prior art, the functional radicals employed are groups, such as carboxyl groups or amino groups, which exhibit charges in dependence on the pH and which have to be reacted, in an additional step, with an activating reagent before a molecule of interest can be bound (Sensing Surfaces capable of Selective Biomolecular Interactions to be used in Sensor Systems, EP-B-0589867). This results in two disadvantages: in the first place, the possibility exists that, as a result of incomplete reaction, charged groups remain present on the surface such that nonspecific adsorption can take place by way of electrostatic interactions, and, in the second place, employing an activating reagent is an additional operational step for the end user, with this step also providing additional opportunities for error.

An object of the invention is therefore to provide articles, such as sensors or quartz balances, or articles which possess microcavities, with surfaces which avoid the disadvantages of the known systems and can readily be manipulated by the end user. Another object of the invention is to provide a process for producing an article of said type. In addition, novel compounds which can be used for producing the abovementioned surfaces should be provided.

The invention consequently relates to an article having an uncharged, functionalized surface which comprises a hydrogel which exhibits hydroxyl groups and to which organic molecules are bound by way of the radicals A, with the organic molecules employed possessing one or more radicals A, which can react with hydroxyl groups, and one or more radicals B, which can react with amino groups or thio groups, and with the radical A, or the radicals A, reacting selectively in the reaction with hydroxyl groups.

A preferred article according to the invention possesses an uncharged functionalized surface which comprises a hydrogel which exhibits hydroxyl groups and to which organic molecules are bound, with the organic molecules employed possessing one or more radicals A selected from acid chloride groups and diazo groups and one or more radicals B selected from vinylsulfone groups, N-hydroxysuccinimide ester groups and maleimide groups.

The invention furthermore provides a process for producing an article having an uncharged, functionalized surface, which process comprises the steps of:

(a) providing an article having an unfunctionalized hydrogel surface, with the hydrogel exhibiting hydroxyl groups;

(b) covalently binding organic molecules which possess one or more radicals A, which can react with hydroxyl groups, and one or more radicals B, which can react with amino groups or thio groups, to the hydrogel,

with the organic molecules reacting selectively with hydroxyl groups of the hydrogel by way of the radical A or the radicals A.

The invention preferably provides a process for producing an article having an uncharged, functionalized surface, which process comprises the steps of:

(a) providing an article having an unfunctionalized hydrogel surface;

(b) binding organic molecules which possess one or more radicals A, selected from acid chloride groups and diazo groups, and one or more radicals B, selected from vinylsulfone groups, N-hydroxysuccinimide ester groups and maleimide groups, to the hydrogel.

The invention furthermore provides novel compounds which possess one or more radicals A, selected from acid chloride groups and diazo groups, and one or more radicals B, selected from vinylsulfone groups, N-hydroxysuccinimide ester groups and maleimide groups.

According to the invention, the above-described article is used for binding biomolecules which possess amino groups or thio groups. These biomolecules serve as receptors for analyte molecules.

The articles according to the invention can be employed as microcavities or in a very wide variety of analytical measuring methods, such as surface plasmon resonance (SPR) or quartz balances, or interferometric measuring methods, e.g. reflection interference contrast microscopy. They are particularly suitable for use in SPR. The constitution of the unfunctionalized surface of the article according to the invention depends on the analytical method in which the article according to the invention is to be employed and is known to the skilled person (Journal of Biomedical Materials Research, 18 953-959) (1984) and (J. Chem. Soc., Chem. Commun., 1990, 1526).

Within the context of the invention, the term “unfunctionalized surface” is used to describe the surface of an article possessing the hydrogel layer prior to the binding of the organic molecules possessing the radicals A and B. The term “functionalized surface” is used to describe the surface of an article possessing the hydrogel layer after the organic molecules possessing the radicals A and B have been bound on. Within the context of the invention, “uncharged” means that, in a pH range of between 4 and 11, preferably between 5 and 9, less than 0.1% of all functional groups on the hydrogel are in a charged state. The charge state of these groups can be calculated by way of their pKₐ value.

The article according to the invention possesses a basal surface which comprises, for example, a glass surface, a metal surface or a plastic surface. Precious metal layers, for example composed of gold or silver, as are used, for example, in SPR, are preferred metal layers. Polyethylene, polypropylene, polystyrene and Macrolon™ are plastic layers which are known in the corresponding applications, e.g. in the case of microcavities.

According to the present invention, it is essential that the unfunctionalized article possesses a hydrogel layer on the surface. This layer serves to prevent non-specific adsorptions which falsify the measured signal. Hydrogels are polymers which can be swelled with water. In order to enable the organic molecules possessing the radicals A to bind on, the hydrogels must exhibit hydroxyl groups. The hydrogels can, for example, be composed of a polysaccharide, a derivative thereof, or a swellable organic polymer such as poly{N-[tris-(hydroxymethyl)methyl]acrylamide}, polyvinyl alcohol or polyethylene glycol possessing terminal hydroxyl groups. Polysaccharides are preferred. Examples of polysaccharides are amylose, inulin, pullulan or dextran. Pullulan or dextran are preferred. Dextran is particularly preferred.

The hydrogel layer should be several nanometers thick. It swells in an aqueous medium to a thickness of approx. 100 nm, resulting in the surface being completely covered. The swollen polymer layer imitates the natural environment of biomolecules and is suitable for preventing denaturation, and consequently inactivation, of the biomolecules. In addition, the adsorption of molecules other than those to be analyzed is effectively suppressed. Furthermore, the swollen hydrogel layer is able to even out irregularities of the surface: the binding of the linker molecules, and consequently of the biomolecules as well, also takes place in the swollen matrix and not only directly at the surface. This thereby reduces the importance of surface unevennesses, which would otherwise contribute to a poorly defined surface and thereby to measurement results which were difficult to quantify.

Methods for coating surfaces with hydrogels are known and vary depending on the article selected, e.g. sensor or microwell (J. of Biomedical Materials Research, 18, 953 (1984), DE-A 198 17 180). For example, an appropriately prepared surface (application DE-A 198 17 180, EP-B-0 589 867) is inserted, for between 1 hour and 5 hours, typically 3 hours, into an appropriate, freshly prepared aqueous hydrogel solution which has been produced from hydroxypolymer. The concentration of the hydroxypolymer in the solution is between 10 and 500 mg·ml⁻¹.

Bifunctional organic molecules, which possess at least one radical A and at least one radical B, are bound to this unfunctionalized hydrogel layer. The radicals A and B are selected such that when the organic molecule is bound to the hydrogel, the radical A reacts selectively with the hydrogel. Since the selectivity of the binding to a hydrogel can only be quantified with difficulty, the degree of selectivity is ascertained, within the context of this invention, by means of a model experiment in solution, with an alcohol being employed as a model compound for the hydroxyl groups of a hydrogel: 0.4 mol of the organic compound to be investigated is added, together with 0.4 mol of isopropanol, to dry dichloromethane. The solution is stirred at 25° C. for 12 hours. After the solvent has been evaporated under negative pressure, the residue is extracted with 500 ml of dichloromethane. The organic phase is washed with 500 ml of water and 500 ml of a 0.1N solution of sodium hydroxide, dried over magnesium sulfate and concentrated by evaporating the solvent. ¹H NMR spectroscopy is used to determine the respective proportion of the products which have been formed by reaction of the radical A with the alcohol and which have been formed by reaction of the radical B with the alcohol. This is determined by comparing the areas under suitably selected product signals. Within the context of the invention, “selective” means that less than 5% of the organic molecules are bound to the alcohol by way of the radical B; preferably less than 1% of the organic molecules are bound to the alcohol by way of radical B. “Binding” is understood as meaning a covalent reaction between the radical and the hydrogel.

Examples of the radical A are: acid chloride groups —COCl and diazo groups

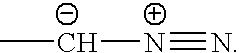

The radical A reacts with the hydroxyl groups of the hydrogel. The functionalization of the hydrogel layer with the bifunctional organic molecules must be effected in such a way that the surface of the article is uncharged. The quantity of the hydroxyl groups of the hydrogel which have reacted with the bifunctional organic molecules is preferably between 5 and 30%, particularly preferably between 8 and 15%.

In addition to the radical A, the organic molecules possess an additional radical B. This radical is selected such that it does not, on the one hand, react under the chosen reaction conditions when the bifunctional organic molecules are being bound on and, on the other hand, can react, without using one or more activating reagents, with a biomolecule possessing amino or thio groups after the bifunctional organic molecules have been bound to the hydrogel. The radical B should be selected such that it can immediately react with a biomolecule possessing amino or thio groups without any further intermediate steps. It is consequently possible, by selecting the radicals A and B while taking account of their different reactivities with the hydrogel and the biomolecule possessing amino or thio groups, to work without using protecting groups for the radical B. This simplifies the process for producing the article according to the invention and furthermore saves costs.

Vinylsulfone groups (I), N-hydroxysuccinimide ester groups (II), maleimide groups (III), or other active ester groups, are, for example, suitable for use as the radical B. * indicates the site of bonding to the remainder of the organic molecule. Vinyl sulfone groups, N-hydroxysuccinimide ester groups and maleimide groups are particularly preferred.

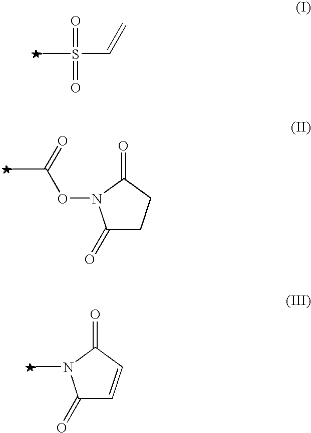

The radicals A and B in the bifunctional organic molecules can be connected by a radical X. The choice of the radical X can vary widely, in connection with which it should neither react with the hydrogel nor with the biomolecule possessing amino or thio groups and not be charged. In the bifunctional organic molecules of the formula A-X-B, the radical X is preferably a single bond or a branched or unbranched hydrocarbon chain which has a chain length of up to 15 carbon atoms and can be interrupted up to two times by in each case a phenylene group or a heteroatom-containing group. Examples of heteroatom-containing groups are —O—, —S—, —CONH— or —COO—. When counting the chain length, the atoms of the heteroatom-containing groups or the carbons of the phenylene groups are riot included in the count. The hydrocarbon chain preferably possesses a chain length of up to 6 carbon atoms. The hydrocarbon chain is preferably unbranched and preferably does not exhibit any phenylene groups or heteroatom-containing radicals. The conditions for synthesizing suitable molecules are heavily dependent on the individual case. Routes for synthesizing selected organic molecules are given in the examples.

Examples of organic molecules of the formula A-X-B are:

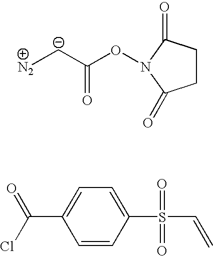

In another possible embodiment, the radicals A and B are bound to a polymer or oligomer. The polymer or oligomer must possess at least one radical A and at least one radical B. The polymer or oligomer preferably possesses radicals A and/or B at at least every fifth repetitive unit. The radicals A and B can, in each case independently of each other, be bound to the backbone of the polymer or oligomer either by way of a spacer (i.e. a hydrocarbon chain which, where appropriate, can be interrupted by heteroatom-containing units, such as amide, ether or sulfide) or else directly. The radicals can be bound to the polymer either terminally or non-terminally.

The polymer or oligomer can be prepared from monomers which possess both a radical A and a radical B. However, it is also possible to synthesize the polymer or oligomer from monomers, with at least one monomer possessing a radical A while at least one second monomer possesses a radical B. It is furthermore possible to synthesize a polymer or oligomer and then to derivatize it with the radicals A and B. Polymerization methods are known to the skilled person (Bruno Vollmert, Grundriβ der Makromolekularen Chemie [Outline of Macromolecular Chemistry], Volume 1. E. Vollmert-Verlag, Karlsruhe 1988).

The backbone of the polymer or oligomer can vary widely, in connection with which it should be chemically inert, i.e. it should neither react with the hydrogel nor with the biomolecule possessing amino or thio groups and nor should it react with the groups A and B. In addition, it should be uncharged. Suitable examples are polyacrylic esters, polymethacrylic esters, polyacrylamides, polyvinyl compounds and polystyrene derivatives or copolymers thereof. Polyacrylic esters or polyacrylamides are particularly suitable. Suitable polymers should have a molar mass of between 5 000 and 20 000 and be soluble in aprotic organic solvents.

The use of low molecular weight compounds as linkers has the advantage that it is possible to work with a compound which is uniform and defined and which can also be readily analyzed before being used. On the other hand, polymers or oligomers offer the advantage of being able to carry several reactive groups per molecule. This facilitates the covalent binding to the hydrogel surface.

The reaction conditions for coupling the bifunctional, organic molecules to the hydrogel layer vary depending on the radicals A and B which are selected and depending on whether low molecular weight compounds of the A-X-B type or polymeric or oligomeric compounds are employed. Examples of these reaction conditions are described below.

The article according to the invention possesses an uncharged surface. In the prior art, activating reagents, such as ethyl-(3-dimethylaminopropyl)carbo-diimide (EDC) and N-hydroxysuccinimide (NHS), are required, in some cases in a separate procedural step, for binding biomolecules to articles such as sensor surfaces. These activating reagents have to be bound to functional groups of the surface in order to convert the latter into a reactive form which only then makes it possible to covalently bond biomolecules to the surface. Since this step has to be carried out by the end user, great interest exists in articles, such as sensors, which do not require this intermediate treatment. When activating reagents are used, it is not possible to quantitatively convert the functional groups on the hydrogel, resulting in biomolecules possessing amino or thio groups only bonding covalently to a portion of the functional groups which are earmarked for this purpose. It has not previously been possible to provide the user with ready-to-use articles which possess an uncharged, functionalized surface, which comprise a hydrogel layer and which were prepared in one step without using protecting groups or activating reagents. There was no knowledge of any suitable reagents of the structure A-X-B whose groups A and B exhibit adequate selectivity and whose groups A are able to react directly with hydroxyl groups of a hydrogel.

The biomolecules which are used in accordance with the invention possess an amino group, preferably a primary or secondary amino group, or a thio group. Examples of suitable biomolecules are proteins, terminally amino-functionalized nucleotides or polynucleotides. The biomolecules typically exhibit the function of receptors. Examples are antibodies (e.g. IgGs) or antigens for particular antibodies, and also substrates for enzymes. The articles according to the invention are particularly suitable for detecting receptor-ligand interactions using methods which are based on affinity interaction.

The conditions under which the covalent binding of the biomolecule possessing amino or thio groups to the article is effected vary depending on the system which is selected. The binding typically takes place at room temperature and in aqueous solution. Typical reaction times are from 10 minutes to 2 hours. The organic molecules are used at a concentration of from 10 μg·ml⁻¹ to 500 μg·ml⁻¹.

The following examples explain the invention in more detail.

### EXAMPLES

### General Remarks

Anhydrous solvents (from SDS) were used on molecular sieves (3-4 Å) as obtained. Column chromatography (from CC): Silicagel 60 (0.040-0.063 mm) from Merck or Silicagel from SDS. Analytical and thin layer chromatography (TLC): silica gel plates from Merck; detection by means of UV (254 nm), I₂, 5% H₂SO₄ or [MoO₄(NH₄)₂ (2.5 g), (NH₄)₂Ce(NO₃)₆ (1.2 g), H₂SO₄ (100 ml, 3.6 M)]. Melting point (m.p.): Büchi 510. ¹H-NMR and ¹³C-NMR spectra: AM-250 Bruker; chemical shifts in ppm based on protonated solvent as the internal reference value (¹H: CHCl₃ in CDCl₃, 7.27 ppm; CHD₂SOCD₃ in CD₃SOCD₃, 2.49 ppm. ¹³C: ¹³CDCl₃ in CDCl₃, 76.9 ppm, ¹³CD₃SOCD₃ in CD₃SOCD₃, 39.6 ppm); coupling constants J in Hz. The mass spectrometric analyses were carried out in the ENS Service de Spectrométrie de masse. The microanalyses were carried out by the Université Pierre et Marie Curie Service de Microanalyses, Paris.

### Example 1

### Preparing Succinimidyl Diazoacetate by Way of Glyoxylic Acid p-toluenesulfonylhydrazone

Glyoxylic acid p-toluenesulfonylhydrazone 1

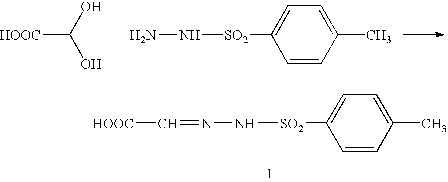

A solution of 80% glyoxylic acid (15.1 g, 0.164 mol) in water (162 ml) is added to a round-bottomed flask and heated to 60° C. in a water bath. A warm (60° C.) solution of p-toluenesulfonylhydrazide (30.37 g, 0.163 mol) in aqueous 2.5 M hydrochloric acid (82 ml) is then added. The resulting mixture is heated in a water bath (60° C.) while stirring continuously. Oil drops form immediately. After approx. 10 minutes, the hydrazone, which initially separated out as an oil, solidifies. The reaction mixture is slowly cooled down to room temperature and then left to stand for 6 hours at 4° C. The crude p-toluenesulfonylhydrazone is filtered, washed with cold water and dried under high vacuum for one day. The compound is then crystallized out. It is dissolved in boiling ethyl acetate (130 ml), which is then diluted with carbon tetrachloride (260 ml). After one night at 4° C., the pure p-toluenesulfonylhydrazone 1 is filtered out of the suspension as a white solid.

Yield: 33.2 g, 84% m.p.: 150° C. ¹H-NMR (DMSO, 250 MHz): δ (ppm): 2.21 (s, 3H, CH₃); 7.02 (s, 1H, NH); 7.27, 7.55 (2d, 4H, J 8.2 Hz, H-ar); 12.12 (s, 1H, ═CH).

Succinimidyl Diazoacetate 2

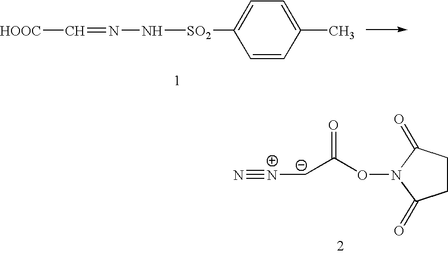

A solution of dicyclohexylcarbodiimide (1.7 g, 8.264 mmol) in dioxane (16 ml) is added dropwise to a solution of N-hydroxysuccinimide (0.951 g, 8.264 mmol) and glyoxylic acid tosylhydrazone 1 (2 g, 8.264 mmol) in cold (0° C.) dioxane (83 ml). The mixture is brought to room temperature and stirred at room temperature for 4 h. The resulting suspension is filtered. The filtrate is concentrated under negative pressure and the crude product is then purified chromatographically on silica gel using dichloromethane as the eluent. Succinimidyl diazoacetate 2 is isolated as a white solid by subsequently crystallizing the compound from CH₂Cl₂/hexane, dissolving it in a small quantity of boiling CH₂Cl₂ and adding hexane.

Yield: 0.759 g, 39% m.p.: 118° C. ¹H-NMR (CDCl₃, 250 MHz): δ(ppm): 2.85 (s, 4H, 2 CH₂ succinimide); 5.12 (s broad, 1H, CH⁻). ¹³C-NMR (CDCl₃, 62.90 MHz): δ(ppm): 25.40 (CH₂-succinimide); 45.03 (CH₂-succinimide); 162.00 (CO-diazoacetyl); 169.30 (CO-succinimide).

### Example 2

### Preparing Succinimidyl Diazoacetate by Way of Glyoxylyl Chloride p-toluenesulfonylhydrazone

Glyoxylyl Chloride p-toluenesulfonylhydrazone 3

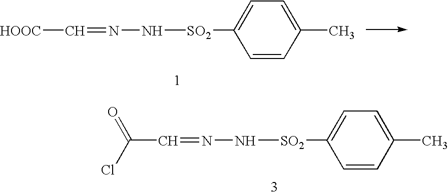

Thionyl chloride (7.2 ml) is added to a suspension of glyoxylic acid p-toluenesulfonylhydrazone 1 (12 g, 49.54 mmol) in dry benzene (60 ml). The mixture is stirred for 5 minutes in a nitrogen atmosphere and then heated under reflux until the powerful evolution of gas (HCl, SO₂) has come to an end and the majority of the suspended solid has dissolved. After from 60 to 90 minutes, the suspension, which is initially white, turns yellow. The mixture is then immediately cooled and filtered through Celite®. After the filtrate has been concentrated under negative pressure, the remaining solid is dissolved in a small quantity of boiling anhydrous benzene. Petroleum ether (30-60° C.) is added to the hot solution. Crystallization starts as the mixture cools. After 1 hour, the hydrazone 3 is isolated by filtering.

Yield: 9.8 g, 76% m.p.: 100-110° C. ¹H-NMR (CDCl₃, 250 MHz): δ (ppm): 2.30 (s, 3H, CH₃) 7.20 (s, 1H, NH); 7.39, 7.67 (2d, 4H, J8.25 Hz, H-ar), 12.36 (s, 1H, ═CH).

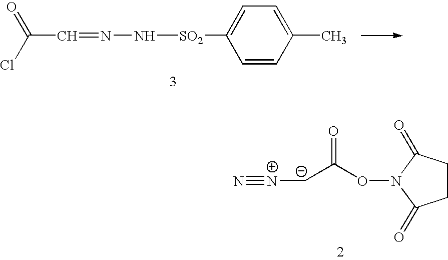

Succinimidyl Diazoacetate 2

A solution of glyoxylyl chloride p-toluenesulfonylhydrazone 3 (9.8 g, 37.63 mmol) in anhydrous dichloromethane (95 ml) is added, during the course of 45 minutes, to a suspension, which is stirred and maintained at 0° C., of N-hydroxysuccinimide (6 g, 52.17 mmol) and dry Na₂CO₃ (7.54 g, 71.16 mmol) in dry dichloromethane (72 ml). After the addition, the resulting suspension is brought to room temperature and stirred at room temperature for 3 hours. The reaction mixture is filtered, firstly through a sand filter and then through Celite®. The filtrate is concentrated under negative pressure. Succinimidyl diazoacetate 2 (yield: 3.44 g, 50%) is isolated by subsequently recrystallizing the crude compound from dichloromethane/hexane, dissolving it in a small quantity of boiling dichloromethane and adding hexane.

### Example 3

### Reactivity of Succinimidyl Diazoacetate

1. Sequential Reactivity on Primary Alcohols and Primary Amines

a) Reaction with Alcohol

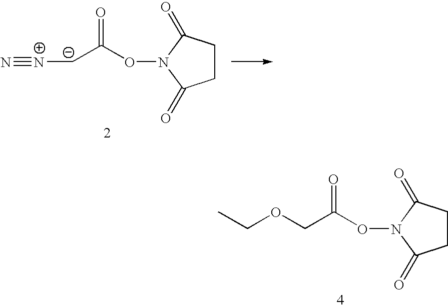

Absolute ethyl alcohol (5 ml) is added, at room temperature, to a solution of succinimidyl diazoacetate 2 (400 mg, 2.186 mmol) in anhydrous dichloromethane (4 ml). The solution is flushed with nitrogen and, after that, boron trifluoride etherate (83 μl) is added slowly. The solution is stirred at room temperature for 3.5 hours. After the solution has been evaporated under negative pressure, the residue is extracted with dichloromethane. The organic phase is washed with water and a 1%-strength solution of sodium hydroxide, dried over magnesium sulfate and then concentrated. The ether-NHS ester 4 is dried under high vacuum for one night. No reaction between alcohol and the bifunctional organic compound is observed in any of the examples.

Yield: 307 mg, 70% ¹H-NMR (CDCl₃, 250 MHz): δ (ppm): 4.42 (s, 2H, CO—CH₂—O); 3.67 (q, 2H, J7 Hz, O—CH₂—CH₃); 2.87 (s, 4H, CH₂-succinimide); 1.27 (t, 3H, O—CH₂—CH₃). ¹³C-NMR (CDCl₃, 62.90 MHz): δ (ppm): 14.91 (CH₃), 25.60 (2 CH₂-succinimide), 65.87 (O—CH₂—CH₃), 67.87 (CO—CH₂—O), 166.06 (COO), 168.79 (2 CO-succinimide). MS (Cl/NH₃) m/z 219 (M+18). HRMS (Cl, CH₄) (M+1): m/z: calculated for C₈H₁₂NO₅:202.0715. Found 202.0707.

b) Reaction with Amines

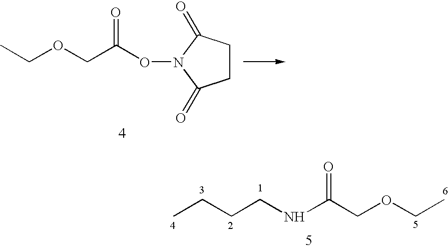

n-Butylamine (42 μl, 0.428 mmol) is added, under a nitrogen atmosphere, to a solution of the alcohol conjugate 4 (43 mg, 0.214 mmol) in anhydrous tetrahydrofuran (1.5 ml). The mixture is stirred at room temperature for 3 hours. After the solvent has been evaporated under negative pressure, the residue is extracted with dichloromethane. The organic phase is washed twice with water and dried over magnesium sulfate. The resulting compound 5 is dried under high vacuum for 2 minutes. Because of its volatility, it is not possible to specify any precise yield after it has been isolated.

¹H-NMR (CDCl₃, 250 MHz): δ (ppm): 0.87 (t, 3H, J_{3,4} 7.24 Hz, CH₃⁴); 1.19 (t, 3H, J_{a,b} 7.03 Hz, CH₃^{b}); 1.53-1.12 (m, 4H, CH₂² and CH₂³); 3.23 (dd, 2H, J_{1,2a} 6.76 Hz, J_{1,2b} 13.23 Hz, CH₂¹); 3.49 (q, 2H, J_{a,b} 7.01 Hz, CH₂^{a}); 3.85 (s, 2H, CO—CH₂—O); 6.5 (s, 1H, NH). ¹³C-NMR (CDCl₃, 62.90 MHz): δ (ppm): 13.74 (CH₃⁴), 15.06 (CH₃^{b}), 20.09 (CH₂³), 31.70 (CH₂²), 38.56 (CH₂¹—NH), 67.11 (O—CH₂^{a}), 69.98 (O—CH₂—CO), 170.00 (CONH). MS (Cl/NH₃) m/z 160 (M+1), 177 (M+18). HRMS (Cl, CH₄) (M+1): m/z: calculated for C₈H₁₈NO₂: 160.1338. Found 160.1348.

2. Sequential Reactivity on Secondary Alcohols and Secondary Amines

a) Reaction with Alcohol

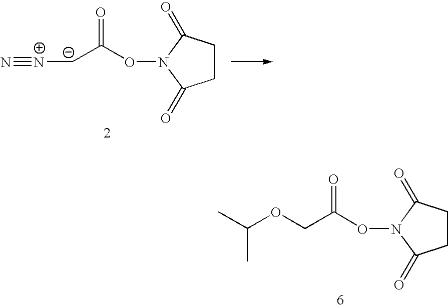

Absolute isopropyl alcohol (1.5 ml) and boron trifluoride etherate (50 μl) are added consecutively, under a nitrogen atmosphere, to a solution of succinimidyl diazoacetate 2 (130 mg, 0.71 mmol) in anhydrous dichloromethane (1.5 ml). The mixture is stirred at room temperature for 3 hours and then warmed under reflux (40° C.) for 1.5 hours. After the solvent has been evaporated under negative pressure, the residue is extracted with dichloromethane. The organic phase is washed with water and a solution of sodium hydroxide, dried under magnesium sulfate and finally concentrated. The dried compound is dissolved in boiling dichloromethane. The crystalline alcohol conjugate 6 is isolated after subsequently diluting with hexane.

Yield: 107 mg, 70% m.p. 49.5-49.8° C. ¹H-NMR (CDCl₃, 250 MHz): δ (ppm): 1.23 (d, 6H, J 6.11 Hz, 2 CH₃iso); 2.86 (s, 4H, 2 CH₂-succinimide); 3.76 (m, 1H, CH-iso); 4.43 (s, 2H, CO—CH₂—O). ¹³C-NMR (CDCl₃, 62.90 MHz): δ (ppm): 21.72 (2 CH₃iso), 25.60 (2 CH₂-succinimide), 63.60 (CH-iso), 73.57 (CO—CH₂—O), 166.48 (COO), 168.83 (2 CO-succinimide). MS (Cl/NH₃) m/z 233 (M+18). Analysis: calculated C₉H₁₃O₅N: C, 50.23; H, 6.088; N, 6.508. Found: C, 50.20; H, 6.21; N, 6.53.

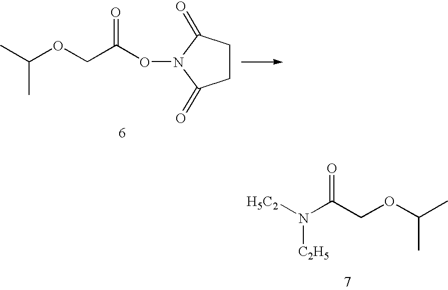

b) Reaction with Diethylamine

Diethylamine (42 μl, 0.404 mmol) is added, under a nitrogen atmosphere, to a solution of the alcohol conjugate 6 (43.4 mg, 0.202 mmol) in anhydrous tetrahydrofuran (1.5 ml). The solution is stirred at room temperature for 3 hours. After the solvent has been evaporated under negative pressure, the residue is extracted with dichloromethane. The organic phase is washed with water and dried over magnesium sulfate. The resulting conjugate 7 is dried under high vacuum for 2 minutes. This liquid compound can be readily distilled; it is not possible to specify a precise yield.

¹H-NMR (CDCl₃, 250 MHz): δ (ppm): 1.06 (t, 3H, J 7.13 Hz, CH₃amine); 1.10 (t, 3H, J 7.5 Hz, CH₃amine); 1.13 (d, 6H, J 6.13 Hz, 2 CH₃iso); 3.28 (q, 2H, CH₂amine); 3.31 (q, 2H, CH₂amine); 3.63 (m, 1H, CH-iso); 4.05 (s, 2H, CO—CH₂—O). ¹³C-NMR (CDCl₃, 62.90 MHz): δ (ppm): 12.85, 14.27 (2 CH₃amine), 21.91 (2 CH₃iso), 40.05, 41.34 (2 CH₂amine), 68.01 (CH-iso), 72.33 (CO—CH₂—O), 168.98 (CON). MS (Cl/NH₃) m/z 174 (M+1). HRMS (Cl, CH₄) (M+1): m/z: calculated for C₉H₂₀NO₂: 174.1494. Found 174.1476.

c) Reaction with Dioctadecylamine

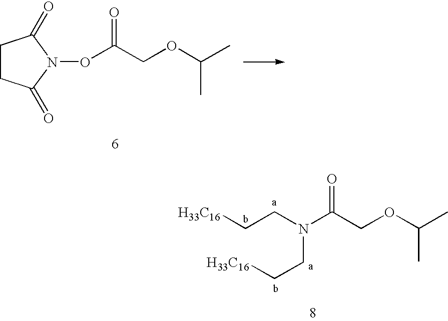

A solution of alcohol conjugate 6 (59.4 mg, 0.277 mmol) and dioctadecylamine (144 mg, 0.277 mmol) in anhydrous tetrahydrofuran (2 ml) is stirred at 50° C. for 3 hours under a nitrogen atmosphere. After the solvent has been evaporated under negative pressure, the residue is extracted with dichloromethane. The organic phase is washed with water. The solvent is then evaporated. The resulting conjugate 8 is dried under high vacuum for 3 hours.

Yield: 150 mg, 87% ¹H-NMR (CDCl₃, 250 MHz): δ (ppm): 0.89 (t, 6H, J 6.89 Hz, 2 CH₃amine); 1.20 (d, 6H, J 6.11 Hz, 2 CH₃iso); 1.26 (s, 60H, 30 CH₂); 1.53 (m, 4H, 2 CH₂^{b}); 3.26 (m, 4H, 2 CH₂^{a}); 3.69 (m, 1H, CH-iso); 4.11 (s, 2H, CO—CH₂—O). ¹³C-NMR (CDCl₃, 62.90 MHz): δ (ppm): 14.12 (2 CH₃amine), 21.91 (2 CH₃iso), 22.72, 26.95, 27.10, 27.56, 29.00, 29.39, 29.46, 29.62, 29.70, 29.73, 31.96 (32 CH₂), 45.77, 47.20 (2 CH₂^{a}), 67.86 (CH-iso), 72.18 (CO—CH₂—O), 169.22 (CO). MS (Cl/NH₃) m/z 622 (M+1). HRMS (Cl, CH₄) (M+1): m/z: calculated for C₄₁H₈₄NO₂: 622.6502. Found 622.6490.

### Example 4

### Preparing 4-vinylsulfonylbenzoyl chloride

1-(2-Chloroethanesulfonyl)-4-methylbenzene 9

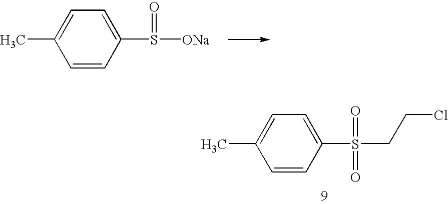

1-Bromo-2-chloroethane (11 ml, 0.132 mol) is added to a solution of the sodium salt of toluene-4-sulfinic acid (19.623 g, 0.11 mol) in dry dimethylformamide (180 ml). The reaction mixture is stirred at room temperature for 2 days. After the solvent has been evaporated under negative pressure, the crude residue is extracted with dichloromethane. The organic phase is washed with water, dried over magnesium sulfate and concentrated. 1-(2-Chloroethanesulfonyl)-4-methylbenzene 9 is isolated as white crystals by subsequently recrystallizing the residue in boiling 80% ethanol.

Yield: 18.58 g, 77% m.p.: 78° C. ¹H-NMR (CDCl₃, 250 MHz): δ (ppm): 2.48 (s, 6H, CH₃); 3.52 (t, 2H, J 7.5 Hz, CH₂SO₂); 3.74 (t, 2H, CH₂Cl); 7.40, 7.80 (2d, 4H, J 8.30 Hz, H-ar).

4-(2-Chloroethanesulfonyl)benzoic acid 10

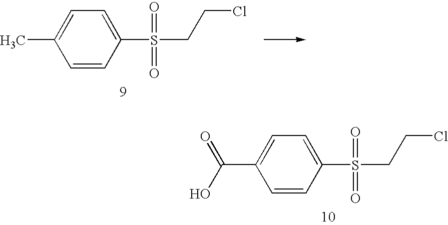

Chromium trioxide (14 g) and concentrated sulfuric acid (9.6 ml) are added consecutively to a solution of 1-(2-chloroethanesulfonyl)-4-methylbenzene 9 (7.687 g, 35.15 mmol) in acetic acid (115 ml). The mixture is stirred at room temperature for 3 hours and then poured into ice water. 4-(2-Chloroethanesulfonyl)benzoic acid 10 is isolated from the white precipitate by filtering it, washing it and recrystallizing it.

Yield: 7.16 g, 82% m.p.: 220° C. ¹H-NMR (DMSO, 250 MHz): δ (ppm): 3.97 (t, 2H, J 6.5 Hz, CH₂SO₂); 4.12 (t, 2H, CH₂Cl); 8.23, 8.34 (2d, 4H, J 8.30 Hz, H-ar), 13.66 (s broad, 1H, OH).

4-Vinylsulfonylbenzoic acid 11

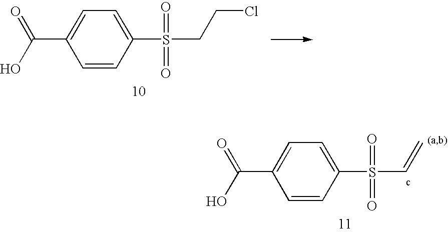

Triethylamine (8.03 ml, 57.6 mmol) is added to a solution of 4-(2-chloroethanesulfonyl)benzoic acid 10 (7.16 g, 28.8 mmol) in chloroform (144 ml). The mixture is stirred at room temperature overnight. After the solvent has been evaporated under negative pressure, the residue is dissolved in water and this solution is filtered in order to separate off the insoluble constituents. Concentrated hydrochloric acid is added to the filtrate. 4-Vinylsulfonylbenzoic acid 11 is isolated from the precipitate by recrystallizing it in water and then filtering and drying under high vacuum.

Yield: 5.10 g, 84% m.p.: 228° C. ¹H-NMR (DMSO, 250 MHz): δ (ppm): 6.26 (d, 1H, J_{a,c} 9.92 Hz, CHa═); 6.38 (d, 1H, J_{b,c} 16.48 Hz, CHb═); 7.15 (dd, 1H, CHc═); 7.96, 8.14 (2d, 4H, J 8.50 Hz, H-ar); 13.56 (s, 1H, OH). ¹³C-NMR (DMSO, 62.90 MHz): δ (ppm): 128.02, 130.69 (4 CH-ar), 130.20, 138.25 (CH═, CH₂═), 135.73, 143.39 (2 Cq-ar), 166.32 (CO).

4-Vinylsulfonylbenzoyl chloride 12

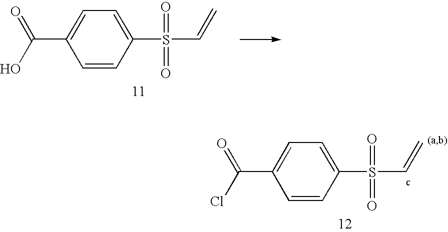

A catalytic quantity of dry dimethylformamide (38 μl, 0.488 mmol) is added, under a nitrogen atmosphere, to a solution of 4-vinylsulfonylbenzoic acid 11 (230 mg, 1.084 mmol) in thionyl chloride (4.6 ml). The mixture is heated (85° C.) under reflux for 3 hours. The solution is evaporated to dryness and the residue is then in each case twice taken up with dry toluene and evaporated to dryness under negative pressure and finally dried under high vacuum for 2 hours. ¹H-NMR (DMSO, 250 MHz): δ (ppm): 6.30 (d, 1H, J_{a,c} 9.85 Hz, CHa═); 6.42 (d, 1H, J_{b,c} 16.47 Hz, CHb═); 7.2 (dd, 1H, CHc═); 8.00, 8.18 (2d, 4H, J 8.54 Hz, H-ar).

### Example 5

### Reactivity of 4-vinylsulfonylbenzoyl chloride

1. Sequential Reactivity on Primary alcohols and Primary Amines

a) Reaction with Alcohol:

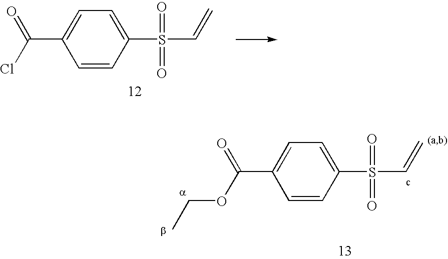

Absolute ethyl alcohol (76 μl, 1.3 mnol) and N,N-diiso-propylethylamine (170 μl, 0.976 mmol) are added consecutively to a solution of 4-vinylsulfonylbenzoyl chloride 12 in anhydrous dichloromethane (4 ml). The mixture is stirred at room temperature overnight. After the solvent has been evaporated under negative pressure, the residue is extracted with dichloromethane. The organic phase is washed with water, dried over magnesium sulfate and finally evaporated to dryness. The analytically pure alcohol conjugate 13 is isolated after purifying-the residue by means of column chromatography on silica gel using dichloromethane as the eluent.

Yield: 206 mg, 79% m.p.: 39-40° C. ¹H-NMR (DMSO, 250 MHz): δ (ppm): 1.51 (t, 3H, J 7.14 Hz, CH₃^{B}); 4.53 (q, 2H, CH₂ₐ); 6.48 (d, 1H, J_{a,c} 9.85 Hz, CHa═); 6.59 (d, 1H, J_{b,c} 16.46 Hz, CHb═); 7.37 (dd, 1H, CHc═); 8.2, 8.36 (2d, 4H, J 8.43 Hz, H-ar). ¹³C-NMR (DMSO, 62.90 MHz): δ (ppm): 14.51 (CH₃), 61.98 (CH₂ₐ), 128.33, 130.73 (4 CH-ar), 130.52 (═CH₂), 134.85 (Cq-ar), 138.40 (═CHc), 143.90 (Cq-ar), 164.96 (COO), MS (Cl/NH₃) m/z 258 (M+18). Analysis: calculated C₁₁H₁₂O₄S: C, 54.98; H, 5.033. Found: C, 55.43; H, 4.96.

b) Reaction with n-butylamine:

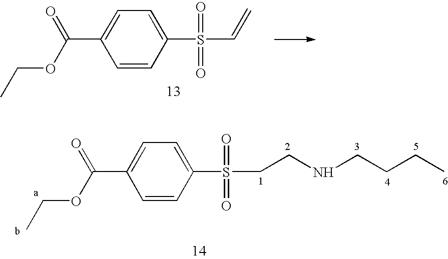

The alcohol conjugate 13 (64.6 mg, 0.269 mmol) and n-butylamine (133 μl, 1.345 mmol) are stirred at room temperature for 12 hours in absolute ethanol (2 ml). The alcoholamine conjugate 14, which is purified for the microanalysis by column chromatography on silica gel using dichloromethane/methanol:20/1 as the eluent, is obtained by evaporating the solvent and the excess n-butylamine.

Yield: 75.8 mg, 90% ¹H-NMR (CDCl₃, 250 MHz): δ (ppm): 0.9 (t, 3H, J_{6,5} 7.1 Hz, CH₃⁶); 1.22-1.49 (m, 4H, CH₂⁴+CH₂⁵); 1.42 (t, 3H, J_{a,b} 7.14 Hz, CH₃^{b}); 2.56 (t, 2H, J_{3,4} 7.07 Hz, CH₂³); 3.03 (t, 2H, J_{1,2} 6.42 Hz, CH₂²); 3.33 (t, 2H, CH₂¹); 4.435 (q, 2H, O—CH₂⁸); 7.21 (m, 1H, NH); 8.00, 8.23 (2d, 4H, J 8.45 Hz, H-ar). ¹³C-NMR (CDCl₃, 62.90 MHz): δ (ppm): 13.918, 14.259 (2 CH₃), 20.326 (CH₂⁵), 31.982 (CH₂⁴), 43.064 (CH₂¹), 49.270 (CH₂²), 61.850 (O—CH₂^{a}), 128.078 (2 CH-ar), 130.426 (2 CH-ar), 135.335 (Cq-ar), 143.138 (Cq-ar), 164.964 (COO). MS (Cl/NH₃) m/z 314 (M+1). Analysis: calculated C₁₅H₂₃O₄NS: C, 57.48; H, 7.396; N, 4.469. Found: C, 57.53; H, 7.41; N, 4.31.

c) Reaction with tert-butylamine:

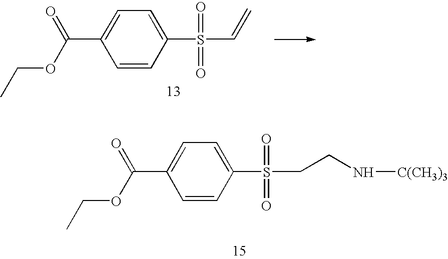

The alcohol conjugate 13 (54.7 mg), 0.228 mmol) and tert-butylamine (120 μl, 1.139 mmol) are stirred at room temperature for 12 hours in absolute ethanol (4 ml). The conjugate 15, which is purified for the microanalysis by column chromatography on silica gel using dichloromethane/methanol: 20/1 as the eluent, is obtained by evaporating the solvent and the excess tert-butylamine.

Yield: 64.1 mg, 90% ¹H-NMR (CDCl₃, 250 MHz): δ (ppm): 1.07 (s, 9H, (CH₃)₃); 1.43 (t, 3H, J 7.13 Hz, CH₂—CH₃); 2.98 (t, 2H, J 6.42 Hz, CH₂—SO₂); 3.31 (t, 2H, CH₂—NH); 4.43 (q, 2H, O—CH₂); 7.22 (m, 1H, NH); 8.00, 8.23 (2d, 4H, J 8.39 Hz, H-ar). ¹³C-NMR (CDCl₃, 62.90 MHz): δ (ppm): 14.25 (CH₂—CH₃), 28.81 ((CH₃)₃), 36.38 (CH₂—SO₂), 50.75 (Cq-aliphatic), 57.27 (CH₂—NH), 61.85 (O—CH₂), 128.09 (2 CH-ar), 130.38 (2 CH-ar), 135.30 (Cq-ar), 143.25 (Cq-ar), 164.98 (COO). MS (Cl/NH₃) m/z 314 (M+1). Analysis: calculated C₁₅H₂₃O₄NS: C, 57.48; H, 7.396; N, 4.469. Found: C, 57.55; H, 7.44; N, 4.39.

2. Sequential Reactivity on Secondary Alcohols and Secondary Amines

a) Reaction with Alcohol:

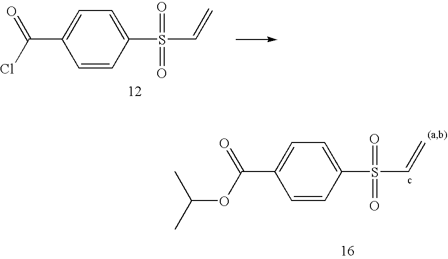

Absolute isopropyl alcohol (202 μl, 2.638 mmol) and N,N-diisopropylethylamine (206.8 μl, 1.187 mmol) are added consecutively to a solution of 4-vinylsulfonylbenzoyl chloride 12 (304.3 mg, 1.319 mmol) in anhydrous dichloromethane (3 ml). The mixture is stirred overnight at room temperature. In order to bring the reaction to an end, a catalytic quantity of dimethylaminopyridine is added to the solution. After an hour, the solvent is evaporated under negative pressure and the residue is then extracted with dichloromethane. The organic phase is washed with water, dried over magnesium sulfate and finally evaporated to dryness. The pure alcohol conjugate 16 is obtained after purifying the residue by column chromatography on silica gel using dichloromethane as the eluent.

Yield: 247 mg, 74% m.p.: 57-58° C. ¹H-NMR (CDCl₃, 250 MHz): δ (ppm): 1.38, 1.41 (2s, 6H, 2 CH₃iso); 5.28 (m, 1H, CH-iso); 6.11 (d, 1H, J_{a,c} 9.44 Hz, Cha═); 6.51 (d, 1H, J_{b,c} 16.5 Hz, CHb═); 6.68 (dd, 1H, CHc═); 7.97, 8.20 (2d, 4H, J 8.70 Hz, H-ar). ¹³C-NMR (CDCl₃, 62.90 MHz): δ (ppm): 21.67 (2 CH₃iso), 69.54 (CH-iso), 127.91 (2 CH-ar), 128.84 (CH₂═), 130.43 (2 CH-ar), 135.60 (Cq-ar), 136.05 (CHc═), 143.30 (Cq-ar), 164.47 (COO). MS (Cl/NH₃) m/z 272 (M+18). Analysis: calculated H₁₂H₁₄O₄S: C, 56.67; H, 5.549. Found: C, 56.65; H, 5.55.

b) Reaction with Amine:

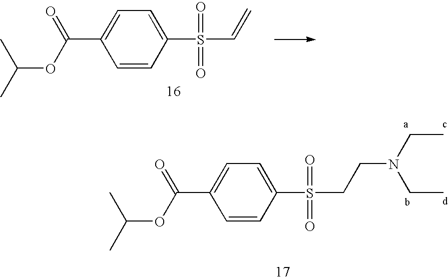

The alcohol conjugate 16 (72.6 mg, 0.286 mmol) and diethylamine (148 μl, 1.431 mmol) are stirred at room temperature for 12 hours in absolute ethanol (2.5 ml). The alcohol-amine conjugate 17, which is purified for the microanalysis by column chromatography on silica gel using dichloromethane/methanol 30/1 as the eluent, is obtained by evaporating the solvent and the excess diethylamine.

Yield: 84 mg, 90%) ¹H-NMR (CDCl₃, 250 MHz): δ (ppm): 0.92 (t, 6H, J_{a,c}=J_{b,d} 7.12 Hz, CH₃ ^{b}); 1.40, 1.42 (2s, 6H, CH₃iso); 2.42 (q, 4H, CH₂ a); 2.90 (m, 2H, CH₂SO₂); 3.28 (m, 2H, CH₂—N); 5.29 (m, 1H, CH-iso); 7.99, 8.22 (2d, 4H, J 8.64 Hz, H-ar). ¹³C-NMR (CDCl₃, 62.90 MHz): δ (ppm): 11.73 (2 CH₃amine), 21.68 (2 CH₃iso), 45.86 (CH₂SO₂), 46.75 (2 CH₂amine), 53.35 (CH₂N), 69.56 (CH-iso), 128.01 (2 CH-ar), 130.26 (2 CH-ar), 135.57 (Cq-ar), 143.34 (Cq-ar), 164.51 (COO). MS (Cl/NH₃) m/z 328 (M+1). Analysis: calculated C₁₆H₂₅O₄NS: C, 58.69; H, 7.695; N, 4.277. Found: C, 58.69; H, 7.70; N, 4.28.

3. Sequential Reactivity on Primary Alcohols and Primary Thiols

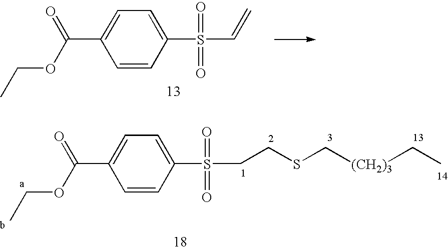

The resulting alcohol conjugate 13 (104 mg, 0.434 mmol) and 1-dodecanethiol (104 μl, 0.434 mmol) are poured, at room temperature, into absolute ethanol (4 ml), and triethylamine (18 μl, 0.130 mmol) is added. The mixture is stirred at room temperature for 2 hours. On its being formed in the ethanol, the alcohol-thiol conjugate crystallizes out. The alcohol-thiol conjugate 18 is isolated from the crystalline compound by filtering, washing with a little ethanol and then drying under high vacuum.

Yield: 165 mg, 86% m.p.: 78-79° C. ¹H-NMR (CDCl₃, 250 MHz): δ (ppm): 0.88 (t, 3H, J_{13,14} 7 Hz, CH₃¹⁴); 1.26 (s, 18H, (CH₂)₉); 1.42 (t, 3H, J_{a,b} 7.09 Hz, CH₃^{b}); 1.5 (m, 2H, CH₂); 2.48 (t, 2H, J 7.24 Hz, CH₂³—S); 2.8 (m, 2H, CH₂²—S); 3.34 (m, 2H, CH₂¹—SO₂); 4.44 (q, 2H, CH₂⁸); 7.99 (d, 2H, J 8.3 Hz, H-ar); 8.24 (d, 2H, H-ar). ¹³C-NMR (CDCl₃, 62.90 MHz): δ (ppm): 14.12, 14.26 (2 CH₃), 22.70, 24.26, 28.75, 29.15, 29.34, 29.49, 29.57, 29.63 (10 CH₂), 31.92, 32.34 (2 CH₂—S), 56.41 (CH₂¹—SO₂), 61.90 (CH₂⁸), 128.22 (2 CH-ar), 130.52 (2 CH-ar), 135.53 (Cq-ar), 142.50 (Cq-ar), 164.91 (COO). MS (Cl/NH₃) m/z 460 (M+18). Analysis: calculated C₂₃H₃₈O₄S₂: C, 62.40; H, 8.652. Found: C, 62.36; H, 8.61.

### Example 6

### Producing an SPR Sensor

An SPR biosensor gold surface, which has been functionalized with a hydrogel, is incubated, for 3 h and under an inert gas atmosphere, in a solution of N-hydroxysuccinimide 2-diazoacetate in dry dichloromethane (5% by weight). It is then rinsed consecutively, in each case once, with dry dichloromethane, isopropanol and highly pure water. After drying in a stream of nitrogen, the surface according to the invention is ready for use.

### Example 7

### Binding Succinimidyl Diazoacetate to a Functionalized SPR Sensor and then Covalently Binding a Receptor

An SPR sensor which has been functionalized with hydrogel is immersed, under an inert gas and at room temperature, for 3 hours in a solution of succinimidyl diazoacetate in dry dichloromethane (5% by weight).

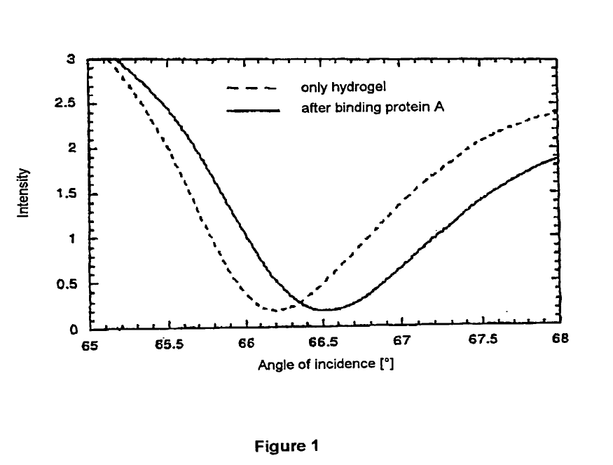

After having been rinsed with dichloromethane, isopropanol and water, the sensor is incubated, at room temperature, with an aqueous solution of protein A in water (150 μg·ml⁻¹). It is then rinsed with a large amount of water. The success of the binding is tested by means of surface plasmon resonance. FIG. 1 shows a comparison of the surface plasmon resonance signals of a hydrogel before and after binding protein A by way of succinimidyl diazoacetate.

1. An article having an uncharged, functionalized surface which comprises a hydrogel which exhibits hydroxyl groups to which organic molecules are bound by way of the radicals A, with the organic molecules employed possessing one or more radicals A, which can react with hydroxyl groups, and one or more radicals B, which can react with amino groups or thio groups, and with the radical A, or the radicals A, reacting selectively in the reaction with hydroxyl groups.

2. An article as claimed in claim 1, with the radicals A being selected from acid chloride groups and diazo groups.

3. An article as claimed in claim 1 or 2, with the radicals B being selected from vinylsulfone groups, N-hydroxysuccinimide ester groups and maleimide groups.

4. An article as claimed in one of claims 1 to 3, with the radicals A and B being linked by means of a single bond or by means of a branched or unbranched hydrocarbon chain X and with the hydrocarbon chain X having a chain length of up to 15 carbon atoms and being able to be interrupted up to two times by in each case a phenylene group or a heteroatom-containing group.

5. An article as claimed in one of claims 1 to 3, with the radicals A and B being bound to a polymer or oligomer.

6. A process for producing an article having an uncharged, functionalized surface, which process comprises the steps of:
(a) providing an article having an unfunctionalized hydrogel surface, with the hydrogel exhibiting hydroxyl groups;
(b) covalently binding organic molecules which possess one or more radicals A, which can react with hydroxyl groups, and one or more radicals B. which can react with amino groups or thio groups, to the hydrogel,
with the organic molecules reacting selectively with hydroxyl groups of the hydrogel by way of the radical A or the radicals A.

7. A compound having one or more radicals A selected from acid chloride groups and diazo groups and one or more radicals B selected from vinylsulfone groups, N-hydroxysuccinimide ester groups and maleimide groups.

8. A compound as claimed in claim 7, with the radicals A and B being linked by means of a single bond or by means of a branched or unbranched hydrocarbon chain X and with the hydrocarbon chain X having a chain length of up to 15 carbon atoms and being able to be interrupted up to two times by in each case a phenylene group or a heteroatom-containing group.

9. A compound as claimed in one of claims 7 or 8, with the radicals A and B being bound to a polymer or oligomer.

10. The use of an article as claimed in one of claims 1 to 5 for reacting with a biomolecule possessing at least one amino group or thio group.
